(19) United States
(12) Patent Application Publication
(10) Pub. No.: US 2011/0255780 A1
(43) Pub. Date: Oct. 20, 2011

(54) METHOD FOR PERFORMING COLOR INTERPOLATION ON A DOWN-SAMPLED BAYER IMAGE, AND ASSOCIATED DEVICE

(76) Inventor: Chao-Kuei Hsieh, Taipei County (TW)

(21) Appl. No.: 12/881,149

(22) Filed: Sep. 13, 2010

(30) Foreign Application Priority Data
Apr. 16, 2010 (TW) 099112030

(51) Int. Cl. G06K 9/00

(52) U.S. Cl. 382/167

(57) ABSTRACT

A method for performing color interpolation on a down-sampled Bayer image includes: with regard to at least one pixel to be interpolated in the down-sampled Bayer image, performing at least one pixel prediction operation according to pixel values of a plurality of neighboring pixels kept by a down-sampling operation, in order to generate at least one simulation pixel value of at least one corresponding simulation pixel of at least one neighboring pixel discarded by the down-sampling operation; and performing at least one color interpolation operation according to at least one pixel value of at least one neighboring pixel kept by the down-sampling operation and the at least one simulation pixel value, in order to generate a pixel value of the at least one pixel to be interpolated. An associated device is also provided.

### BACKGROUND OF THE INVENTION

1. Field of the Invention

The present invention relates to real time image processing, and more particularly, to a method for performing color interpolation on a down-sampled Bayer image, and to an associated device.

2. Description of the Prior Art

According to the related art, an image sensor can generate an original image in a normal mode, where each pixel of the original image only includes a pixel value corresponding to a color channel, and does not include complete image information such as all pixel values respectively corresponding to red, green, and blue channels. In addition, the image sensor can discard a portion of pixel values in a down-sampling mode to generate a down-sampled Bayer image. Similarly, each pixel of the down-sampled Bayer image only includes a pixel value corresponding to a color channel, and does not include complete image information such as all pixel values respectively corresponding to the red, the green, and the blue channels.

Regarding the down-sampled Bayer image, the related art typically utilizes conventional color interpolation algorithms designed for the original image to perform color interpolation, without giving consideration to whether the conventional color interpolation algorithms are suitable for the down-sampled Bayer image. As a result, some problems may occur. For example, in a situation where an interpolation image is obtained from performing color interpolation on the down-sampled Bayer image by utilizing the conventional color interpolation algorithms, a great amount of erroneous image information may exist in this interpolation image. Thus, a novel method is required for improving the quality of color interpolation images.

### SUMMARY OF THE INVENTION

It is therefore an objective of the claimed invention to provide a method for performing color interpolation on a down-sampled Bayer image, and to provide an associated device, in order to solve the above-mentioned problems.

According to a preferred embodiment of the claimed invention, a method for performing color interpolation on a down-sampled Bayer image comprises: with regard to at least one pixel to be interpolated in the down-sampled Bayer image, performing at least one pixel prediction operation according to pixel values of a plurality of neighboring pixels kept by a down-sampling operation, in order to generate at least one simulation pixel value of at least one corresponding simulation pixel of at least one neighboring pixel discarded by the down-sampling operation; and performing at least one color interpolation operation according to at least one pixel value of at least one neighboring pixel kept by the down-sampling operation and the at least one simulation pixel value, in order to generate a pixel value of the at least one pixel to be interpolated.

While the method mentioned above is disclosed, an associated device for performing color interpolation on a down-sampled Bayer image is further provided. The device comprises at least one pixel prediction module and at least one color interpolation module. With regard to at least one pixel to be interpolated in the down-sampled Bayer image, the at least one pixel prediction module performs at least one pixel prediction operation according to pixel values of a plurality of neighboring pixels kept by a down-sampling operation, in order to generate at least one simulation pixel value of at least one corresponding simulation pixel of at least one neighboring pixel discarded by the down-sampling operation. In addition, the at least one color interpolation module is arranged to perform at least one color interpolation operation according to at least one pixel value of at least one neighboring pixel kept by the down-sampling operation and the at least one simulation pixel value, in order to generate a pixel value of the at least one pixel to be interpolated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of an electronic device according to a first embodiment of the present invention.

FIG. 1B illustrates at least a portion of pixels of an original image involved with the image signal processor shown in FIG. 1A according to an embodiment of the present invention.

FIG. 1C illustrates some implementation details of the image signal processor shown in FIG. 1A according to an embodiment of the present invention.

FIG. 2 is a flowchart of a method for performing color interpolation on a down-sampled Bayer image according to an embodiment of the present invention.

FIGS. 3A-3F respectively illustrate pixels involved with the method shown in FIG. 2 in different situations according to an embodiment of the present invention.

### DETAILED DESCRIPTION

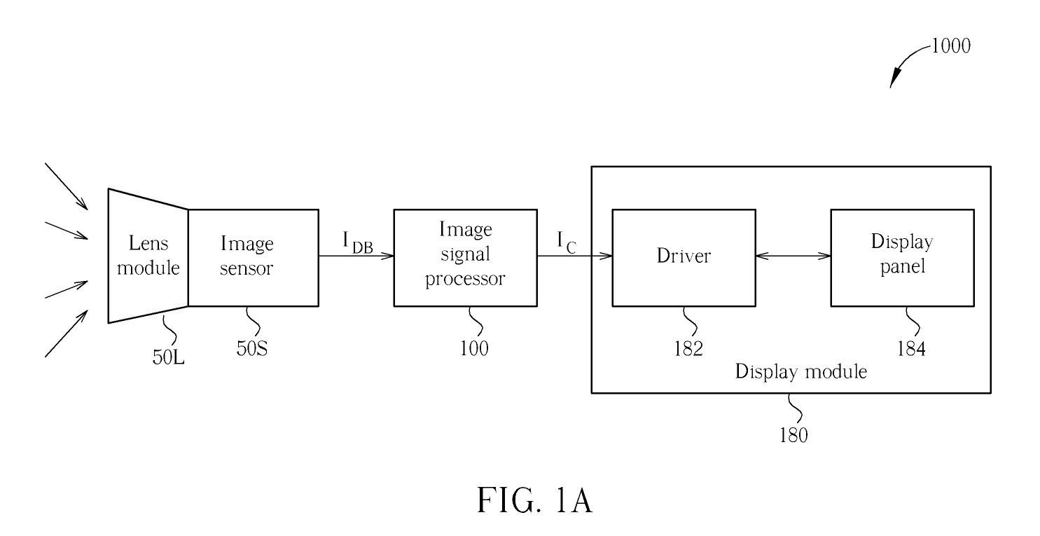

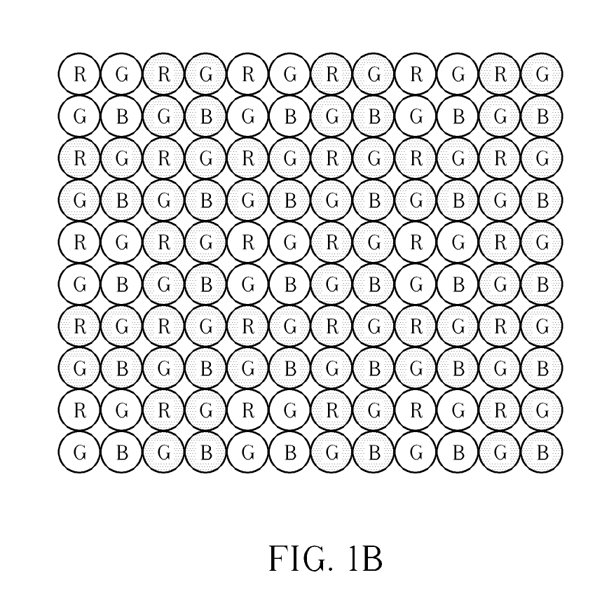

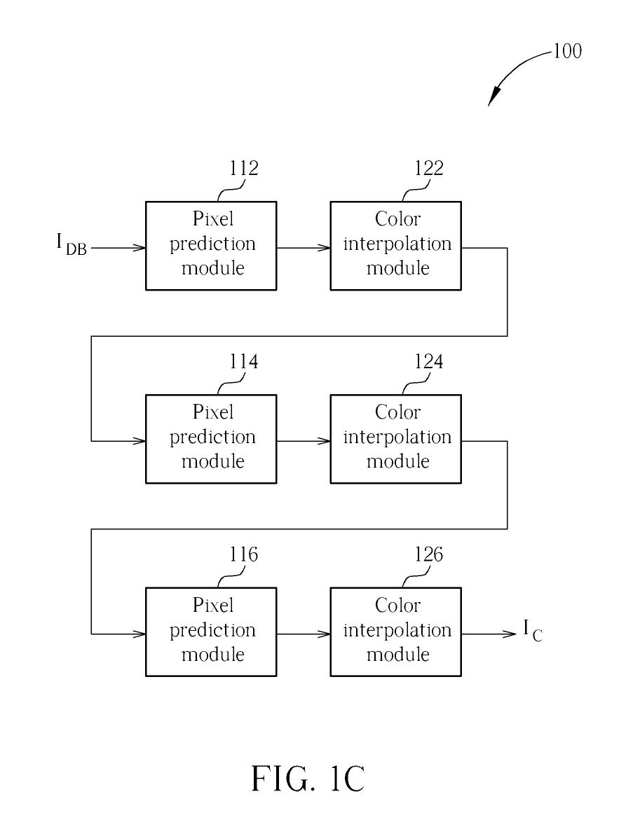

Please refer to FIGS. 1A-1B. FIG. 1A is a diagram of an electronic device 1000 according to a first embodiment of the present invention, where the electronic device 1000 comprises a lens module 50L, an image sensor 50S, an image signal processor 100, and a display module 180, and the display module 180 comprises a driver 182 and a display panel 184. The image sensor 50S is capable of sensing images received through the lens module 50L, and selectively generating an original image I_{B} in a normal mode or generating a down-sampled Bayer image I_{DB} in a down-sampling mode. More particularly, in the down-sampling mode, when obtaining image data of the original image I_{B}, the image sensor 50S performs a down-sampling operation to discard a portion of pixel values of the original image I_{B}, such as the pixel values of the pixels illustrated with shaded circles in FIG. 1B, and to output pixel values of the pixels illustrated with non-shaded circles in FIG. 1B as image data of the down-sampled Bayer image I_{DB}. Here, no matter whether the original image I_{B} or the down-sampled Bayer image I_{DB} is under consideration, each pixel only includes a pixel value corresponding to a color channel, and does not include complete image information such as all pixel values respectively corresponding to red, green, and blue channels. For example, referring to FIG. 1B, any of the pixels labeled with the notation “R” only includes a pixel value corresponding to the red channel, any of the pixels labeled with the notation “G” only includes a pixel value corresponding to the green channel, and any of the pixels labeled with the notation “B” only includes a pixel value corresponding to the blue channel.

As each pixel of either the original image I_{B} or the down-sampled Bayer image I_{DB} does not include complete image information, within the electronic device 1000, a device for performing color interpolation on the original image I_{B} or the down-sampled Bayer image I_{DB}, such as the image signal processor 100 shown in FIG. 1A, is needed in order to generate complete image information, for use of real time display of the display module 180. For example, the image signal processor 100 can perform color interpolation on the down-sampled Bayer image I_{DB} to generate a corresponding color interpolation image I_{c} (each pixel of which includes complete image information such as all pixel values respectively corresponding to the red, the green, and the blue channels), and the driver 182 can receive the color interpolation image I_{c} and drive the display panel 184 accordingly to display the color interpolation image I_{c}, where the image signal processor 100 can also perform some image processing operations to change image information of the color interpolation image l_{c}. This is for illustrative purposes only, and is not meant to be a limitation of the present invention. According to a variation of this embodiment, the image signal processor 100 can perform color interpolation on the original image I_{B} to generate the corresponding color interpolation image l_{c} (each pixel of which includes complete image information such as all pixel values respectively corresponding to the red, the green, and the blue channels).

Please refer to FIG. 1C, which illustrates some implementation details of the image signal processor 100 shown in FIG. 1A according to an embodiment of the present invention. The image signal processor 100 comprises at least one pixel prediction module such as pixel prediction modules 112, 114, and 116, and further comprises at least one color interpolation module such as color interpolation modules 122, 124, and 126. According to this embodiment, with regard to at least one pixel to be interpolated in the down-sampled Bayer image I_{DB}, the aforementioned at least one pixel prediction module performs at least one pixel prediction operation according to pixel values of a plurality of neighboring pixels kept by the down-sampling operation, in order to generate at least one simulation pixel value of at least one corresponding simulation pixel of at least one neighboring pixel discarded by the down-sampling operation. In addition, the aforementioned at least one color interpolation module performs at least one color interpolation operation according to at least one pixel value of at least one neighboring pixel kept by the down-sampling operation and the at least one simulation pixel value, in order to generate a pixel value of the aforementioned at least one pixel to be interpolated.

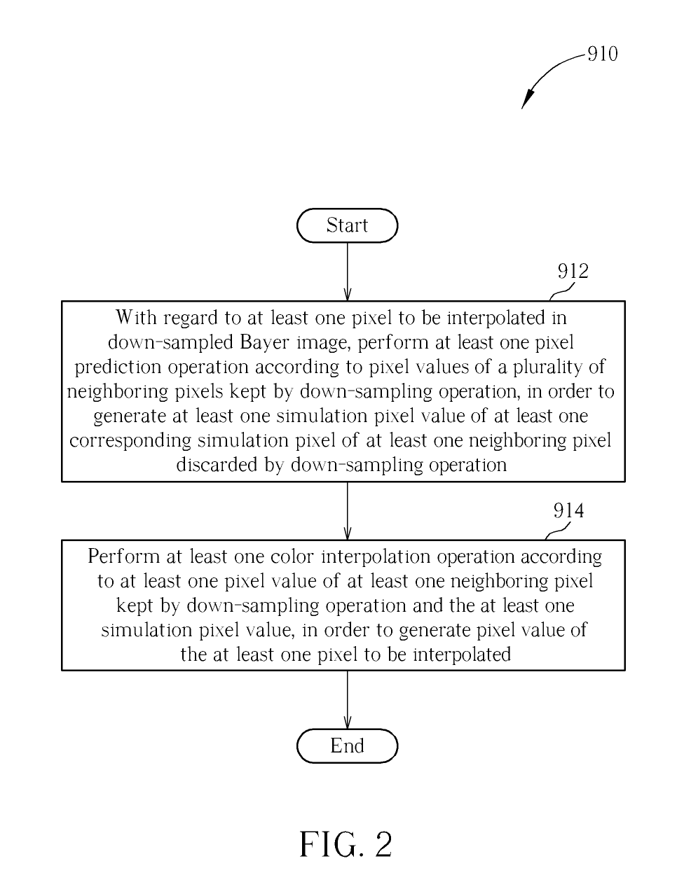

In practice, the image signal processor 100 can be implemented with a controller executing program code, and the controller comprises hardware circuits for executing the program code, where the aforementioned at least one pixel prediction module and the aforementioned at least one color interpolation module are program modules within the program code. For example, the program code can be firmware code. In another example, the program code can be read only memory (ROM) code. This is for illustrative purposes only, and is not meant to be a limitation of the present invention. According to a variation of this embodiment, at least a portion of the image signal processor 100 (e.g. a portion of the modules shown in FIG. 1C, or all of the modules shown in FIG. 1C) can be implemented with logic circuits. Referring to FIG. 2, related details of performing the aforementioned color interpolation by utilizing the image signal processor 100 are further described as follows.

FIG. 2 is a flowchart of a method 910 for performing color interpolation on a down-sampled Bayer image such as the aforementioned down-sampled Bayer image I_{DB} according to an embodiment of the present invention. The method can be applied to the image signal processor 100 shown in FIG. 1A, and more particularly, to the controller mentioned above. In addition, the method can be implemented by utilizing the image signal processor 100 shown in FIG. 1A, and more particularly, by utilizing the controller mentioned above. The method 910 is described as follows.

Step 912: With regard to at least one pixel to be interpolated in the down-sampled Bayer image I_{DB}, the aforementioned at least one pixel prediction module (e.g. the pixel prediction modules 112, 114, and/or 116) performs at least one pixel prediction operation according to pixel values of a plurality of neighboring pixels kept by the down-sampling operation, in order to generate at least one simulation pixel value of at least one corresponding simulation pixel of at least one neighboring pixel discarded by the down-sampling operation.

Step 914: The aforementioned at least one color interpolation module (e.g. the color interpolation modules 122, 124, and/or 126) performs at least one color interpolation operation according to at least one pixel value of at least one neighboring pixel kept by the down-sampling operation and the at least one simulation pixel value, in order to generate a pixel value of the aforementioned at least one pixel to be interpolated. More particularly, the aforementioned at least one color interpolation operation comprises color interpolation operations respectively corresponding to the red, the green, and the blue channels, for use of generating pixel values corresponding to the red, the green, and the blue channels, respectively.

According to this embodiment, the aforementioned at least one neighboring pixel kept by the down-sampling operation and the aforementioned at least one corresponding simulation pixel are utilized for simulating at least a portion of a simulation image I_{S} of the original image I_{B}, from which the down-sampled Bayer image I_{DB} originates through the down-sampling operation. Please note that, no matter whether the portion of the simulation image I_{S} is absolutely equivalent to or similar to the corresponding portion of the original image I_{B}, the performance of color interpolation implemented by utilizing the method 910 is always better than the performance of any related art architecture that does not perform any simulation of pixels discarded by the down-sampling operation.

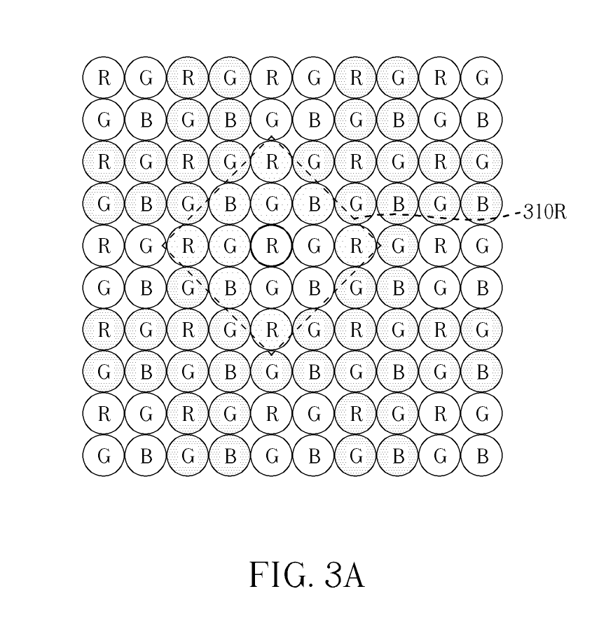

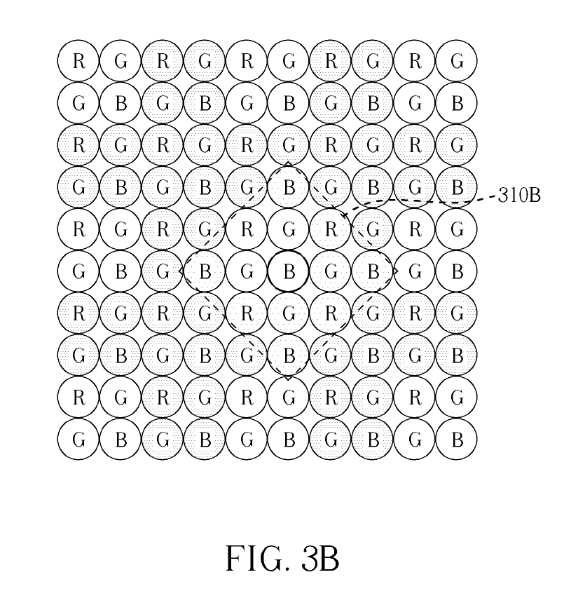

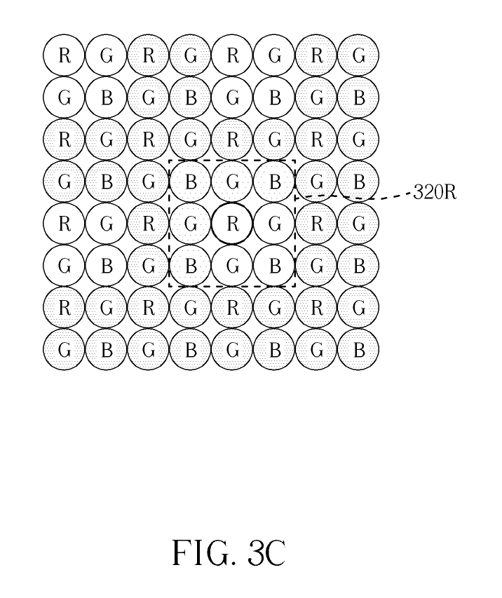

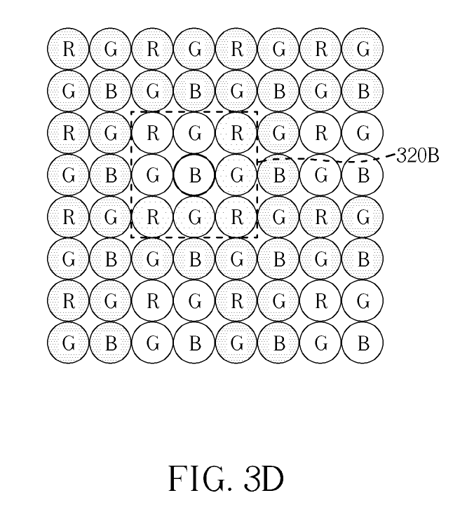

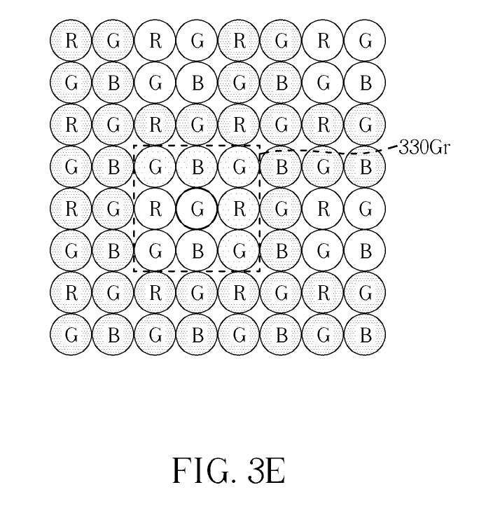

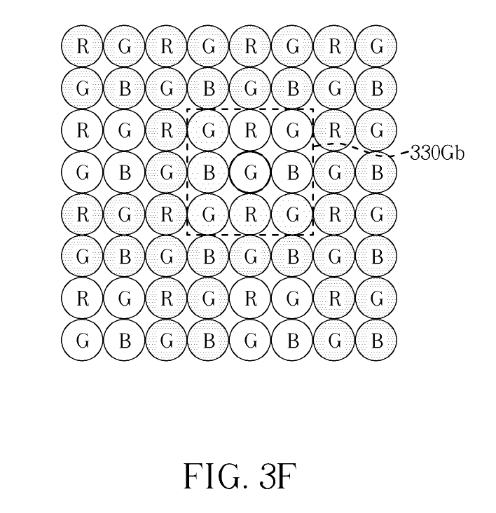

FIGS. 3A-3F respectively illustrate pixels involved with the method 910 shown in FIG. 2 in different situations according to an embodiment of the present invention. In any of the situations respectively shown in FIGS. 3A-3B, within the simulation image I_{S}, the arrangement of pixels involved with the color interpolation operation for use of generating pixel values corresponding to the green channel (e.g. a portion of the color interpolation operation performed by the color interpolation module 122) forms a rhombus (or a diamond), where the respective lengths of the diagonals of the rhombus (or the diamond) can be equal to each other in this embodiment. The details thereof are described as follows.

As shown in FIG. 3A, within the simulation image I_{S}, the arrangement of pixels involved with the color interpolation operation for use of generating pixel values corresponding to the green channel (e.g. a portion of the color interpolation operation performed by the color interpolation module 122) forms the rhombus 310R. More particularly, the pixels corresponding to the rhombus 310R comprise 13 pixels, where the central pixel within the rhombus 310R represents the pixel to be interpolated in this situation, and has already included the pixel value of the red channel, and therefore, is labeled “R”. Thus, in a situation where the pixel to be interpolated includes a pixel value corresponding to the red channel as kept by the down-sampling operation (e.g. the pixel value of the red channel), within the simulation image I_{S}, pixels on each diagonal of the rhombus 310R correspond to a red-green-red-green-red (R-G-R-G-R) color pattern (i.e. the R-G-R-G-R color pattern illustrated in FIG. 3A, on each diagonal of the rhombus 310R). According to the pixel values of the neighboring pixels kept by the down-sampling operation, the pixel prediction module 112 can respectively calculate simulation pixel values of the pixels within the rhombus 310R that are discarded by the down-sampling operation (i.e. the lightly shaded pixels illustrated in FIG. 3A). As a result, when calculating the pixel value of the green channel regarding the pixel to be interpolated, by utilizing the trends of lightness variations of the image formed with pixels corresponding to at least one different color channel (e.g. the red channel and/or the blue channel) within the rhombus 310R, the color interpolation module 122 can adjust the pixel value of the green channel regarding the pixel to be interpolated, in order to properly emulate the real image.

Similarly, as shown in FIG. 3B, within the simulation image I_{S}, the arrangement of pixels involved with the color interpolation operation for use of generating pixel values corresponding to the green channel (e.g. a portion of the color interpolation operation performed by the color interpolation module 122) forms the rhombus 310B. More particularly, the pixels corresponding to the rhombus 310B comprise 13 pixels, where the central pixel within the rhombus 310B represents the pixel to be interpolated in this situation, and has already included the pixel value of the blue channel, and therefore, is labeled “B”. Thus, in a situation where the pixel to be interpolated includes a pixel value corresponding to the blue channel as kept by the down-sampling operation (e.g. the pixel value of the blue channel), within the simulation image Is, pixels on each diagonal of the rhombus 310B correspond to a blue-green-blue-green-blue (B-G-B-G-B) color pattern (i.e. the B-G-B-G-B color pattern illustrated in FIG. 3B, on each diagonal of the rhombus 310B). According to the pixel values of the neighboring pixels kept by the down-sampling operation, the pixel prediction module 112 can respectively calculate simulation pixel values of the pixels within the rhombus 310B that are discarded by the down-sampling operation (i.e. the lightly shaded pixels illustrated in FIG. 3B). As a result, when calculating the pixel value of the green channel regarding the pixel to be interpolated, by utilizing the trends of lightness variations of the image formed with pixels corresponding to at least one different color channel (e.g. the red channel and/or the blue channel) within the rhombus 310B, the color interpolation module 122 can adjust the pixel value of the green channel regarding the pixel to be interpolated, in order to properly emulate the real image.

In addition, in any of the situations respectively shown in FIGS. 3C-3F, within the simulation image I_{S}, the arrangement of pixels involved with the color interpolation operation for use of generating pixel values corresponding to a non-green channel (e.g. a portion of the color interpolation operation performed by any of the color interpolation modules 124 and 126) forms a square, where the non-green channel represents the red channel or the blue channel. The details thereof are described as follows.

As shown in FIG. 3C, within the simulation image I_{S}, the arrangement of pixels involved with the color interpolation operation for use of generating pixel values corresponding to the blue channel (e.g. a portion of the color interpolation operation performed by the color interpolation module 124) forms the square 320R. More particularly, the pixels corresponding to the square 320R comprise 9 pixels, where the central pixel within the square 320R represents the pixel to be interpolated in this situation, and has already included the pixel value of the red channel, and therefore, is labeled “R”. Thus, in a situation where the pixel to be interpolated includes a pixel value corresponding to the red channel as kept by the down-sampling operation (e.g. the pixel value of the red channel), within the simulation image I_{S}, pixels on each edge of the square 320R correspond to a blue-green-blue (B-G-B) color pattern (i.e. the B-G-B color pattern illustrated in FIG. 3C, on each edge of the square 320R). According to the pixel values of the neighboring pixels kept by the down-sampling operation, the pixel prediction module 114 can respectively calculate simulation pixel values of the pixels within the square 320R that are discarded by the down-sampling operation (i.e. the lightly shaded pixels illustrated in FIG. 3C). As a result, when calculating the pixel value of the blue channel regarding the pixel to be interpolated, by utilizing the trends of lightness variations of the image formed with pixels corresponding to a different color channel (e.g. the green channel) within the square 320R, the color interpolation module 124 can adjust the pixel value of the blue channel regarding the pixel to be interpolated, in order to properly emulate the real image.

Similarly, as shown in FIG. 3D, within the simulation image I_{S}, the arrangement of pixels involved with the color interpolation operation for use of generating pixel values corresponding to the red channel (e.g. a portion of the color interpolation operation performed by the color interpolation module 124) forms the square 320B. More particularly, the pixels corresponding to the square 320B comprise 9 pixels, where the central pixel within the square 320B represents the pixel to be interpolated in this situation, and has already included the pixel value of the blue channel, and therefore, is labeled “B”. Thus, in a situation where the pixel to be interpolated includes a pixel value corresponding to the blue channel as kept by the down-sampling operation (e.g. the pixel value of the blue channel), within the simulation image Is, pixels on each edge of the square 320B correspond to a red-green-red (R-G-R) color pattern (i.e. the R-G-R color pattern illustrated in FIG. 3D, on each edge of the square 320B). According to the pixel values of the neighboring pixels kept by the down-sampling operation, the pixel prediction module 114 can respectively calculate simulation pixel values of the pixels within the square 320B that are discarded by the down-sampling operation (i.e. the lightly shaded pixels illustrated in FIG. 3D). As a result, when calculating the pixel value of the red channel regarding the pixel to be interpolated, by utilizing the trends of lightness variations of the image formed with pixels corresponding to a different color channel (e.g. the green channel) within the square 320B, the color interpolation module 124 can adjust the pixel value of the red channel regarding the pixel to be interpolated, in order to properly emulate the real image.

As shown in FIG. 3E, within the simulation image I_{S}, the arrangement of pixels involved with the color interpolation operation for use of generating pixel values corresponding to the non-green channel such as the red channel or the blue channel (e.g. a portion of the color interpolation operation performed by the color interpolation module 126) forms the square 330Gr. More particularly, the pixels corresponding to the square 330Gr comprise 9 pixels, where the central pixel within the square 330Gr represents the pixel to be interpolated in this situation, and has already included the pixel value of the green channel, and therefore, is labeled “G”. Thus, in a situation where the pixel to be interpolated includes a pixel value corresponding to the green channel as kept by the down-sampling operation (e.g. the pixel value of the green channel), within the simulation image I_{S}, pixels on an edge of the square 330Gr correspond to a green-blue-green (G-B-G) color pattern (i.e. the G-B-G color pattern illustrated in FIG. 3E, on a horizontal edge of the square 330Gr), and pixels on another edge of the square 330Gr correspond to a green-red-green (G-R-G) color pattern (i.e. the G-R-G color pattern illustrated in FIG. 3E, on a vertical edge of the square 330Gr). According to the pixel values of the neighboring pixels kept by the down-sampling operation, the pixel prediction module 116 can respectively calculate simulation pixel values of the pixels within the square 330Gr that are discarded by the down-sampling operation (i.e. the lightly shaded pixels illustrated in FIG. 3E). As a result, when calculating the pixel value of the non-green channel regarding the pixel to be interpolated, by utilizing the trends of lightness variations of the image formed with pixels corresponding to at least one different color channel (e.g. the green channel and/or the other non-green channel) within the square 330Gr, the color interpolation module 126 can adjust the pixel value of the non-green channel regarding the pixel to be interpolated, in order to properly emulate the real image.

Similarly, as shown in FIG. 3F, within the simulation image I_{S}, the arrangement of pixels involved with the color interpolation operation for use of generating pixel values corresponding to the non-green channel such as the red channel or the blue channel (e.g. a portion of the color interpolation operation performed by the color interpolation module 126) forms the square 330Gb. More particularly, the pixels corresponding to the square 330Gb comprise 9 pixels, where the central pixel within the square 330Gb represents the pixel to be interpolated in this situation, and has already included the pixel value of the green channel, and therefore, is labeled “G”. Thus, in a situation where the pixel to be interpolated includes a pixel value corresponding to the green channel as kept by the down-sampling operation (e.g. the pixel value of the green channel), within the simulation image I_{S}, pixels on an edge of the square 330Gb correspond to a G-B-G color pattern (i.e. the G-B-G color pattern illustrated in FIG. 3F, on a vertical edge of the square 330Gb), and pixels on another edge of the square 330Gb correspond to a G-R-G color pattern (i.e. the G-R-G color pattern illustrated in FIG. 3F, on a horizontal edge of the square 330Gb). According to the pixel values of the neighboring pixels kept by the down-sampling operation, the pixel prediction module 116 can respectively calculate simulation pixel values of the pixels within the square 330Gb that are discarded by the down-sampling operation (i.e. the lightly shaded pixels illustrated in FIG. 3F). As a result, when calculating the pixel value of the non-green channel regarding the pixel to be interpolated, by utilizing the trends of lightness variations of the image formed with pixels corresponding to at least one different color channel (e.g. the green channel and/or the other non-green channel) within the square 330Gb, the color interpolation module 126 can adjust the pixel value of the non-green channel regarding the pixel to be interpolated, in order to properly emulate the real image.

It is an advantage of the present invention that the present invention method and device can provide color interpolation images having extremely high quality. In contrast to the related art, when performing color interpolation on the down-sampled Bayer image, the present invention method and device can perform at least one pixel prediction operation in order to generate at least one simulation pixel value of at least one corresponding simulation pixel of at least one neighboring pixel discarded by the down-sampling operation. Therefore, the present invention can prevent erroneous image information from being generated.

Those skilled in the art will readily observe that numerous modifications and alterations of the device and method may be made while retaining the teachings of the invention.

What is claimed is:

1. A method for performing color interpolation on a down-sampled Bayer image, the method comprising:
with regard to at least one pixel to be interpolated in the down-sampled Bayer image, performing at least one pixel prediction operation according to pixel values of a plurality of neighboring pixels kept by a down-sampling operation, in order to generate at least one simulation pixel value of at least one corresponding simulation pixel of at least one neighboring pixel discarded by the down-sampling operation; and
performing at least one color interpolation operation according to at least one pixel value of at least one neighboring pixel kept by the down-sampling operation and the at least one simulation pixel value, in order to generate a pixel value of the at least one pixel to be interpolated.

2. The method of claim 1, wherein the at least one color interpolation operation comprises color interpolation operations respectively corresponding to red, green, and blue channels, for use of generating pixel values corresponding to the red, the green, and the blue channels, respectively.

3. The method of claim 2, wherein the at least one neighboring pixel kept by the down-sampling operation and the at least one corresponding simulation pixel are utilized for simulating at least a portion of a simulation image of an original image, from which the down-sampled Bayer image originates through the down-sampling operation.

4. The method of claim 3, wherein within the simulation image, arrangement of pixels involved with the color interpolation operation for use of generating pixel values corresponding to the green channel forms a rhombus.

5. The method of claim 4, wherein in a situation where the pixel to be interpolated includes a pixel value corresponding to the red channel as kept by the down-sampling operation, within the simulation image, pixels on each diagonal of the rhombus correspond to a red-green-red-green-red (R-G-R-G-R) color pattern.

6. The method of claim 4, wherein in a situation where the pixel to be interpolated includes a pixel value corresponding to the blue channel as kept by the down-sampling operation, within the simulation image, pixels on each diagonal of the rhombus correspond to a blue-green-blue-green-blue (B-G-B-G-B) color pattern.

7. The method of claim 3, wherein within the simulation image, arrangement of pixels involved with the color interpolation operation for use of generating pixel values corresponding to a non-green channel forms a square; and the non-green channel represents the red channel or the blue channel.

8. The method of claim 7, wherein in a situation where the pixel to be interpolated includes a pixel value corresponding to the red channel as kept by the down-sampling operation, within the simulation image, pixels on each edge of the square correspond to a blue-green-blue (B-G-B) color pattern.

9. The method of claim 7, wherein in a situation where the pixel to be interpolated includes a pixel value corresponding to the blue channel as kept by the down-sampling operation, within the simulation image, pixels on each edge of the square correspond to a red-green-red (R-G-R) color pattern.

10. The method of claim 7, wherein in a situation where the pixel to be interpolated includes a pixel value corresponding to the green channel as kept by the down-sampling operation, within the simulation image, pixels on an edge of the square correspond to a green-blue-green (G-B-G) color pattern, and pixels on another edge of the square correspond to a green-red-green (G-R-G) color pattern.

11. A device for performing color interpolation on a down-sampled Bayer image, the device comprising:
at least one pixel prediction module, wherein with regard to at least one pixel to be interpolated in the down-sampled Bayer image, the at least one pixel prediction module performs at least one pixel prediction operation according to pixel values of a plurality of neighboring pixels kept by a down-sampling operation, in order to generate at least one simulation pixel value of at least one corresponding simulation pixel of at least one neighboring pixel discarded by the down-sampling operation; and
at least one color interpolation module arranged to perform at least one color interpolation operation according to at least one pixel value of at least one neighboring pixel kept by the down-sampling operation and the at least one simulation pixel value, in order to generate a pixel value of the at least one pixel to be interpolated.

12. The device of claim 11, wherein the at least one color interpolation operation comprises color interpolation operations respectively corresponding to red, green, and blue channels, for use of generating pixel values corresponding to the red, the green, and the blue channels, respectively.

13. The device of claim 12, wherein the at least one neighboring pixel kept by the down-sampling operation and the at least one corresponding simulation pixel are utilized for simulating at least a portion of a simulation image of an original image, from which the down-sampled Bayer image originates through the down-sampling operation.

14. The device of claim 13, wherein within the simulation image, arrangement of pixels involved with the color interpolation operation for use of generating pixel values corresponding to the green channel forms a rhombus.

15. The device of claim 14, wherein in a situation where the pixel to be interpolated includes a pixel value corresponding to the red channel as kept by the down-sampling operation, within the simulation image, pixels on each diagonal of the rhombus correspond to a red-green-red-green-red (R-G-R-G-R) color pattern.

16. The device of claim 14, wherein in a situation where the pixel to be interpolated includes a pixel value corresponding to the blue channel as kept by the down-sampling operation, within the simulation image, pixels on each diagonal of the rhombus correspond to a blue-green-blue-green-blue (B-G-B-G-B) color pattern.

17. The device of claim 13, wherein within the simulation image, arrangement of pixels involved with the color interpolation operation for use of generating pixel values corresponding to a non-green channel forms a square; and the non-green channel represents the red channel or the blue channel.

18. The device of claim 17, wherein in a situation where the pixel to be interpolated includes a pixel value corresponding to the red channel as kept by the down-sampling operation, within the simulation image, pixels on each edge of the square correspond to a blue-green-blue (B-G-B) color pattern.

19. The device of claim 17, wherein in a situation where the pixel to be interpolated includes a pixel value corresponding to the blue channel as kept by the down-sampling operation, within the simulation image, pixels on each edge of the square correspond to a red-green-red (R-G-R) color pattern.

20. The device of claim 17, wherein in a situation where the pixel to be interpolated includes a pixel value corresponding to the green channel as kept by the down-sampling operation, within the simulation image, pixels on an edge of the square correspond to a green-blue-green (G-B-G) color pattern, and pixels on another edge of the square correspond to a green-red-green (G-R-G) color pattern.
